(19) United States
(12) Patent Application Publication
(10) Pub. No.: US 2024/0237080 A9
(43) Pub. Date: Jul. 11, 2024

(54) RANDOM ACCESS WITH SLICE GRANT FOR PRIORITIZED SLICES

(71) Applicant: Telefonaktiebolaget LM Ericsson (publ), Stockholm (SE)

(72) Inventors: Jan CHRISTOFFERSSON, Luleå (SE); Min WANG, Luleå (SE); Ylva TIMNER, Luleå (SE); Tomas FRANKKILA, Luleå (SE)

(21) Appl. No.: 18/547,576

(22) PCT Filed: Feb. 28, 2022
(86) PCT No.: PCT/IB2022/051741

§ 371 Date: Aug. 23, 2023

Related U.S. Application Data
(60) Provisional application No. 63/155,108, filed on Mar. 1, 2021.

(51) Int. Cl. H04W 74/0833

(52) U.S. Cl. CPC H04W 74/0833

(57) ABSTRACT

A method, system and apparatus for random access with slice grants for prioritized slices are disclosed. According to one aspect, a method includes receiving a physical random access channel (PRACH) message from a wireless device (WD). The method also includes transmitting at least one random access response (RAR), message the at least one RAR message being configured to provide at least a first grant and a second grant, the first grant configured to grant uplink resources to a WD on a low priority slice, the second grant configured to grant uplink resources to a WD on a high priority slice.

### TECHNICAL FIELD

The present disclosure relates to wireless communications, and in particular, to random access with slice grants for prioritized slices.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD), as well as communication between network nodes and between WDs. Sixth Generation (6G) wireless communication systems are also under development.

An example of a current 5G radio access network (RAN) architecture is described in 3GPP Technical Standard (TS) 38.401 and is depicted in FIG. 1.

The NG architecture can be further described as follows:
The NG-RAN includes a set of network nodes, e.g., LTE base stations (eNBs) and New Radio base stations (gNBs) connected to the 5G core (5GC) through an NG interface;
An eNB/gNB can support frequency division duplex (FDD) operation, time division duplex (TDD) operation or dual mode operation;
eNB/gNBs can be interconnected through the Xn interface;
A gNB may include a gNB centralized unit (CU) and one or more gNB distributed units (DUs);
A gNB-CU and a gNB-DU are connected via an F1 logical interface; and
One gNB-DU is connected to only one gNB-CU.

NG, Xn and F1 are logical interfaces. For NG-RAN, the NG and Xn-C interfaces for a gNB consisting of a gNB-CU and gNB-DUs, terminate in the gNB-CU. The gNB-CU and connected gNB-DUs are only visible to other gNBs and the 5GC as a gNB.

The NG-RAN is layered. There is a Radio Network Layer (RNL) and a Transport Network Layer (TNL). The NG-RAN architecture, which includes the NG-RAN logical nodes and the interfaces between them, is defined as part of the RNL. For each NG-RAN interface (NG, Xn, F1) the related TNL protocol and the functionality are specified. The TNL provides services for user plane transport and signaling transport.

Network Slicing in 3GPP Technical Release 15 (3GPP Rel-15)

Network slicing involves creating logically separated partitions of the network where each partition addresses a different business purpose. These “network slices” are logically separated to a degree that they can be regarded and managed as networks of their own.

This concept potentially applies to both LTE and NR radio access technologies (RATs). A driver for introducing network slicing is business expansion, i.e., improving the cellular network operator's ability to serve other industries, e.g., by offering connectivity services with different network characteristics (performance, security, robustness, and complexity).

The current working assumption is that there will be one shared Radio Access Network (RAN) infrastructure that will connect to several core network (CN) instances (with one or more Common Control Network Functions, CCNF, interfacing the radio access network (RAN), plus additional CN functions which may be slice-specific). As the CN functions are being virtualized, it is assumed that the operator will instantiate a new CN, or part of it, when a new slice should be supported. An example of this architecture is shown in FIG. 2. Slice 0 can for example be a Mobile Broadband slice and Slice 1 can for example be a Machine Type Communication network slice.

Network Slicing in 3GPP Rel 17, Considerations related to Random Access

For 3GPP NR Release 17, a study is ongoing to investigate enhancements to network slicing. One aspect is to study enhancements to the random access channel (RACH) to enable fast access to a slice. Two solutions have been identified:
Solution 1 (RACH isolation): a slice-specific separate RACH resource pool can be configured per slice or per slice group, in addition to the existing common RACH resources; and
Solution 2 (RACH prioritization): slice-specific RACH parameters prioritization can be configured per slice or per slice group.

In 3GPP RAN2 #113-e, RAN2 has considered and identified open issues regarding slice based RACH configuration, including:
Separated PRACH configuration (e.g., transmission occasions of time-frequency domain and preambles) can be configured for slice or slice group;
Existing RACH parameters prioritization (i.e., scalingFactorBI and powerRampingStepHighPriority) can be supported as baseline for slices;
Slice group is supported. Whether to define a new grouping mechanism or reuse a unified access control (UAC) access category is left to a work item (WI) phase;
The following open issues are being considered:
a) For slice specific RACH, how to perform RACH type selection (e.g., 2-step & 4-step);
b) The fallback mechanism, e.g., whether to support 2 step slice-based RACH fallback to 4-step slice-based/common RACH;
c) The collision in case that slice-specific random access RA prioritization is configured together with legacy RA prioritization (e.g., multimedia priority service (MPS) & modulation and coding scheme (MCS) wireless devices (WDs));
   Solution 1 (RACH isolation) & solution 2 (RACH prioritization) can work independently in a complementary way; and/or
   Both solution 1 and solution 2 for slice-based RACH configuration are considered for normative work.

4-Step Random Access Procedure

A 4-step approach is used in 3GPP NR Release 15 for the Random Access (RA) procedure. Referring to FIG. 3, the WD detects Synchronization Signals (SS) and decodes the broadcasted system information, followed by transmitting a PRACH preamble (message 1) in the uplink. The gNB replies with a RAR (Random Access Response, message 2) which uses the RA-radio network temporary identifier (RNTI) and preamble ID for identification. The WD then transmits a WD identification (message 3) on the physical uplink shared channel (PUSCH) using an uplink grant (i.e., an allocation of uplink transmission resources).

The WD transmits message 3 (on the PUSCH) after receiving a timing advance command in the RAR, allowing the PUSCH to be received with a timing accuracy within the Cyclic Prefix (CP). Without this timing advance, a very large CP would be needed in order to be able to demodulate and detect the PUSCH, unless the system is applied in a cell with only a very small distance between WD and eNB. Since NR will also support larger cells with a need for providing a timing advance to the WD, the 4-step approach is needed for a random access procedure.

In 3GPP NR Release 15 (Rel-15), the WD will indicate a synchronization signal block (SSB). The purpose of this is to let the gNB know which direction (i.e., which downlink (DL) beam to use) to transmit the RAR and subsequent messages. The SSB selection by the WD is done by comparing the synchronization signal reference signal received power (SS-RSRP) to the rsrp-ThresholdSSB.

Once the SSB has been selected, the indication from the WD to the gNB is done by selection of a preamble and/or a PRACH occasion (RO), depending on the configuration. With the use of specific preambles and/or RO, the WD implicitly indicates the selected SSB to the gNB.

The RAR format is further described in 3GPP TS 38.321 section 6.2.2 and 6.1.5 copied below:
“6.2.2 MAC subheader for Random Access Response
The MAC subheader consists of the following fields:
   E: The Extension field is a flag indicating if the MAC subPDU including this MAC subheader is the last MAC subPDU or not in the MAC PDU. The E field is set to “1” to indicate at least another MAC subPDU follows. The E field is set to “0” to indicate that the MAC subPDU including this MAC subheader is the last MAC subPDU in the MAC PDU;
   T: The Type field is a flag indicating whether the MAC subheader contains a Random Access Preamble ID or a Backoff Indicator. The T field is set to “0” to indicate the presence of a Backoff Indicator field in the subheader (BI). The T field is set to “1” to indicate the presence of a Random Access Preamble ID field in the subheader (RAPID);
   R: Reserved bit, set to “0”;
   BI: The Backoff Indicator field identifies the overload condition in the cell. The size of the BI field is 4 bits;
   RAPID: The Random Access Preamble IDentifier field identifies the transmitted Random Access Preamble (see clause 5.1.3). The size of the RAPID field is 6 bits. If the RAPID in the MAC subheader of a MAC subPDU corresponds to one of the Random Access Preambles configured for SI request, MAC RAR is not included in the MAC subPDU.
The MAC subheader is octet aligned.
6.1.5 MAC PDU (Random Access Response)
A MAC PDU consists of one or more MAC subPDUs and optionally padding. Each MAC subPDU consists one of the following:
   a MAC subheader with Backoff Indicator only;
   a MAC subheader with RAPID only (i.e., acknowledgment for SI request);
   a MAC subheader with RAPID and MAC RAR.”

A MAC subheader with Backoff Indicator consists of five header fields E/T/R/R/BI as described in FIG. 4. A MAC subPDU with Backoff Indicator only is placed at the beginning of the MAC PDU, if included. ‘MAC subPDU(s) with RAPID only’ and ‘MAC subPDU(s) with RAPID and MAC RAR’ can be placed anywhere between MAC subPDU with Backoff Indicator only (if any) and padding (if any).

A MAC subheader with RAPID consists of three header fields E/T/RAPID as described in FIG. 5.

Padding is placed at the end of the MAC PDU if present. Presence and length of padding is implicit based on TB size, size of MAC subPDU(s). See also, FIG. 6.

2-Step Random Access Procedure

The 2-step RA procedure was standardized in 3GPP NR Release 16. With the 2-step procedure the random access is completed in only two steps as illustrated in FIG. 7, for example:
Step 1: The WD sends a message A (msgA) including a random access preamble together with higher layer data such as a radio resource control (RRC) connection request, possibly with some small payload on the PUSCH (denoted “msgA PUSCH”). The msgA PUSCH is used for small data transmissions in an inactive state or mode; and
Step 2: The gNB sends a response called message B (msgB) (which may be described as a modified RAR) including a WD identifier assignment, timing advance information, and a contention resolution message, etc. In addition, message B may contain a higher layer part. Similar to an RAR, a msgB may contain responses to multiple msgAs, and thus, to multiple WDs. But the optional higher layer part can only pertain to one of the responses (i.e., to one of the msgAs/WDs). If a response in a msgB does not have an associated higher layer part, this will be sent in a separate subsequent message, e.g., an RRC message, on the physical downlink shared channel (PDSCH). MsgB is identified by a MsgB-RNTI.

The msgA contains a preamble transmission and a PUSCH transmission where the preamble is mapped to the PUSCH. This means that when a particular preamble is selected, the preamble implies which time and frequency and demodulation reference signal (DMRS) sequence is used for the PUSCH transmission

The msgB is a response to msgA, which may contain contention resolution message(s), fallback indication(s) to schedule Msg3 transmission, and back off indication.

The msgB is a response to msgA, which may contain responses to multiple WDs and with different kinds of information for different WDs depending on the outcome of the msgA transmission/reception (and the load on the access resources).

Upon a successful msgA reception, the gNB includes a successRAR medium access control (MAC) subPDU as a response for the concerned WD, where the successRAR MAC subPDU includes a contention resolution identity, a timing advance and a C-RNTI allocation.

If the gNB successfully received the RACH preamble, but failed to receive the msgA PUSCH, the gNB can respond to the concerned WD with a fallbackRAR MAC subPDU in the msgB. The fallbackRAR essentially turns the 2-step RA into a 4-step RA. Consequently, the fallbackRAR MAC subPDU contains an UL grant, a timing advance and a temporary C-RNTI (TC-RNTI) allocation, but no contention resolution identity. The WD uses the UL grant to retransmit msgA PUSCH in the form of Msg3.

In addition to successRAR and fallbackRAR MAC subPDUs, the gNB may include a parameter which is intended for the WDs that did not find any response to their respective msgA transmissions in msgB. This parameter is the Backoff Indicator (a single parameter for all WDs which did not find their expected response in the msgB), which controls whether and how much a WD must wait until it can attempt to access the network through random access again.

At RAN2 #113-e, RAN2 has considered the following regarding a slice-based RACH configuration:
1. Separated PRACH configuration (e.g., transmission occasions of time-frequency domain and preambles) can be configured for slice or slice group;
2. Existing RACH parameters prioritization (i.e., scalingFactorBI and powerRampingStepHighPriority) can be supported as baseline for slices;
3. Slice group is supported. Whether to define a new grouping mechanism or reusing UAC access category is left to WI phase;
4. Solution 1 (RACH isolation) & 2 (RACH prioritization) can work independently in a complementary way; and
5. Both solution 1 and solution 2 for slice-based RACH configuration are recommended for normative work.

From the above considerations, it is observed that the RACH prioritization feature (i.e., based on scalingFactorBI and powerRampingStepHighPriority), which was designed in 3GPP NR Release 15 (3GPP Rel-15), will be extended to prioritize slice-based RACH accesses, i.e., referred to as Solution 2. In this solution, the same RA resources (i.e., preambles, ROs, PUSCH) are shared among different slices and legacy WDs. Even with RA differentiation (i.e., RA procedures on different slices are not differentiated), there will be collisions between preambles, Msg3 and MsgA PUSCH transmissions among RA procedures. Prioritization aims to alleviate the problems with collisions and increase the probability that the high priority slice obtains service compared to the low priority slice and legacy WDs. The following examples of methods to do this have been discussed:
High priority back-off: making low priority WDs back off longer than high priority WDs. Effective after preamble collision or msg3/msgA collision;
High priority preamble ramping power: making high priority WDs transmit preamble with higher power than low priority WDs, thereby increasing the detection probability for the high priority WD. Effective after preamble collision or msg3/msgA collision; and
Higher priority msgA PUSCH power offset (for the 2-step procedure): making high priority WDs transmit msgA PUSCH with higher power than low priority WDs. Effective for a first transmission but will increase interference for all WDs.

A problem with these methods (for 4-step RA) is that they are only effective after the first preamble transmission has failed, thereby increasing the latency of the RA procedure while at the same time increasing the latency even more for low priority users.

### SUMMARY

Some embodiments advantageously provide methods, systems, and apparatuses for random access with slice grants for prioritized slices.

Some embodiments include methods to give two grants in RAR for msg3, thereby avoiding collisions between legacy WDs or low priority slice WDs and high priority slice WDs. This can also be achieved by defining a slice specific search space so that slice WDs get their own RAR or a new RA-RNTI (indicating the slice) so that only the slice gets a RAR. Legacy WDs look for the RAR on the legacy SS/RA-RNTI. At high load, only an RAR to slice WD is sent. This may be combined with a set of “shared preambles”, e.g., a legacy WD may use all preambles and slice a subset. At high load, the radio base station (e.g., gNB, network node, etc.) may prioritize to give grants to slice WDs (shared preambles).

Some embodiments achieve a lower collision probability and hence, better random access performance for high priority slice WDs.

According to one aspect, a network node configured to communicate with a wireless device, WD, the network node comprising: a radio interface configured to: receive a physical random access channel, PRACH, message from the WD; and transmit at least one random access response, RAR, message, the at least one RAR message being responsive to the received PRACH message from the WD and configured to provide at least a first grant and a second grant, the first grant configured to grant uplink resources to a WD on a first slice, the second grant configured to grant uplink resources to a WD on a second slice.

According to this aspect, in some embodiments, one of the first slice and the second slice is of a higher priority than the other of the first slice and the second slice. In some embodiments, the first grant and the second grant are included in one RAR message. In some embodiments, an RAR message includes a preamble, the preamble indicating whether a grant provided by the RAR message is one of: for a WD on a low priority slice only; and for a WD on either one of a low priority slice and a high priority slice. In some embodiments, the radio interface is further configured to respond with the first grant only, when the preamble falls within a first PRACH transmission occasion, and to respond with both the first grant and the second grant when the preamble falls within a second PRACH occasion. In some embodiments, the second grant is added to a same medium access control, MAC, packet data unit, PDU as the first grant, the second grant being placed as a last RAR message of the MAC PDU. In some embodiments, the second grant is included in downlink control information, DCI. In some embodiments, the network node further includes processing circuitry configured to define a random access-radio network temporary identifier, RA-RNTI, that identifies the RAR message.

According to another aspect, a method implemented in a network node configured to communicate with a WD is provided. The method includes: receiving a physical random access channel, PRACH, message from the WD; and transmitting at least one random access response, RAR, message, the at least one RAR message being responsive to the received PRACH message from the WD and configured to provide at least a first grant and a second grant, the first grant configured to grant uplink resources to a WD on a first slice, the second grant configured to grant uplink resources to a WD on a second slice.

According to this aspect, in some embodiments, one of the first slice and the second slice is of a higher priority than the other of the first slice and the second slice. In some embodiments, the first grant and the second grant are included in one RAR message. In some embodiments, an RAR message includes a preamble, the preamble indicating whether a grant provided by the RAR message is one of: for a WD on a low priority slice only; and for a WD on either one of a low priority slice and a high priority slice. In some embodiments, the method also includes responding with the first grant only, when the preamble falls within a first PRACH transmission occasion, and responding with both the first grant and the second grant when the preamble falls within a second PRACH occasion. In some embodiments, the second grant is added to a same medium access control, MAC, packet data unit, PDU as the first grant, the second grant being placed as a last RAR message of the MAC PDU. In some embodiments, the second grant is included in downlink control information, DCI. In some embodiments, the method also includes defining a random access-radio network temporary identifier, RA-RNTI that identifies the RAR message.

According to yet another aspect, a WD is configured to communicate with a network node. The WD includes a radio interface configured to receive a grant in a random access response, RAR, message, the RAR message being in response to a physical random access channel, PRACH, message sent by the WD. The WD also includes processing circuitry in communication with the radio interface and configured to identify a grant in the RAR message corresponding to one of a first slice and a second slice.

According to this aspect, in some embodiments, one of the first slice and the second slice is of a higher priority than the other of the first slice and the second slice. In some embodiments, the processing circuitry is further configured to monitor one of a plurality of search spaces for an RAR message transmission corresponding to one of the first slice and the second slice, each search space corresponding to a slice. In some embodiments, the grant in the RAR message corresponding to the first slice is indicated in a preamble, the preamble indicating a second grant. In some embodiments, the radio interface is further configured to listen for a physical downlink control channel, PDCCH, transmission addressed to a random access radio network temporary identifier, RA-RNTI, to identify the RAR message.

According to another aspect, a method implemented in a wireless device (WD) includes: receiving a grant in a random access response, RAR, message, the RAR message being in response to a physical random access channel, PRACH, message sent by the WD; and identifying a grant in the RAR message corresponding to one of a first slice and a second slice.

According to this aspect, in some embodiments, the method also includes monitoring one of a plurality of search spaces for an RAR message transmission corresponding to one of the first slice and the second slice, each search space corresponding to a slice. In some embodiments, the grant in the RAR message corresponding to the first slice is indicated in a preamble, the preamble indicating a second grant. In some embodiments, the method also includes listening for a physical downlink control channel, PDCCH, transmission addressed to a random access radio network temporary identifier, RA-RNTI, to identify the RAR message.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a diagram of a 5G architecture;

FIG. 2 is a diagram of an architecture partitioning a network into slices;

FIG. 3 is a diagram of a 4 step random access procedure;

FIG. 4 is a reproduction of FIG. 6.1.5-1 of 3GPP TS 38.321 showing a medium access control (MAC) subheader;

FIG. 5 is a reproduction of FIG. 6.1.5-2 of 3GPP TS 38.321 showing a medium access control (MAC) subheader;

FIG. 6 is a reproduction of FIG. 6.1.5-3 of 3GPP TS 38.321 showing a MAC packet data unit (PDU) having MAC RARs;

FIG. 7 is a diagram of a 2 step random access procedure;

FIG. 8 is a schematic diagram of an example network architecture illustrating a communication system connected via an intermediate network to a host computer according to the principles in the present disclosure;

FIG. 9 is a block diagram of a host computer communicating via a network node with a wireless device over an at least partially wireless connection according to some embodiments of the present disclosure;

FIG. 10 is a flowchart illustrating example methods implemented in a communication system including a host computer, a network node and a wireless device for executing a client application at a wireless device according to some embodiments of the present disclosure;

FIG. 11 is a flowchart illustrating example methods implemented in a communication system including a host computer, a network node and a wireless device for receiving user data at a wireless device according to some embodiments of the present disclosure;

FIG. 12 is a flowchart illustrating example methods implemented in a communication system including a host computer, a network node and a wireless device for receiving user data from the wireless device at a host computer according to some embodiments of the present disclosure;

FIG. 13 is a flowchart illustrating example methods implemented in a communication system including a host computer, a network node and a wireless device for receiving user data at a host computer according to some embodiments of the present disclosure;

FIG. 14 is a flowchart of an example process in a network node for random access with slice grants for prioritized slices;

FIG. 15 is a flowchart of an example process in a wireless device for random access with slice grants for prioritized slices;

FIG. 16 is a flowchart of another example process in a network node for random access with slice grants for multiple slices;

FIG. 17 is a flowchart of another example process in a wireless device for random access with slice grants for multiple slices; and

FIG. 18 is an example of placement of new RAR in a medium access control (MAC) packet data unit (PDU).

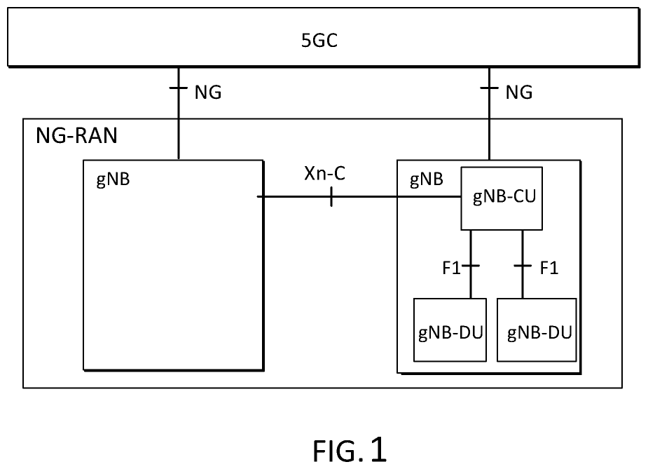

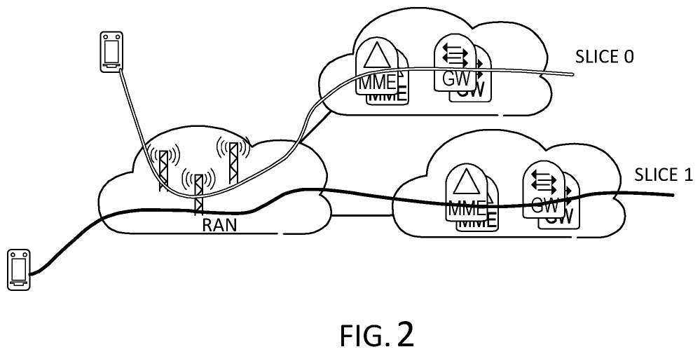

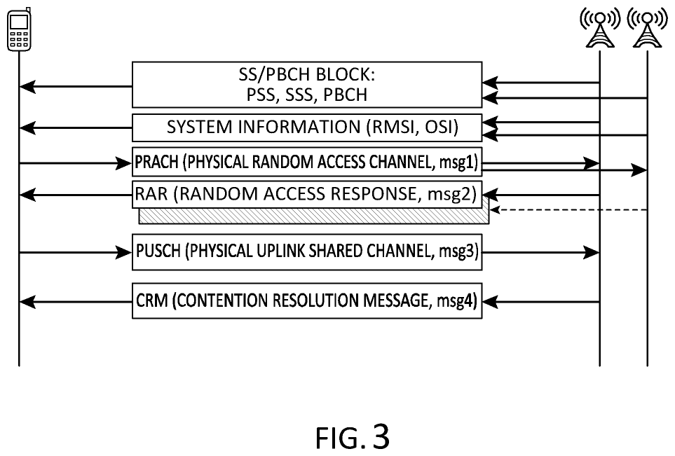

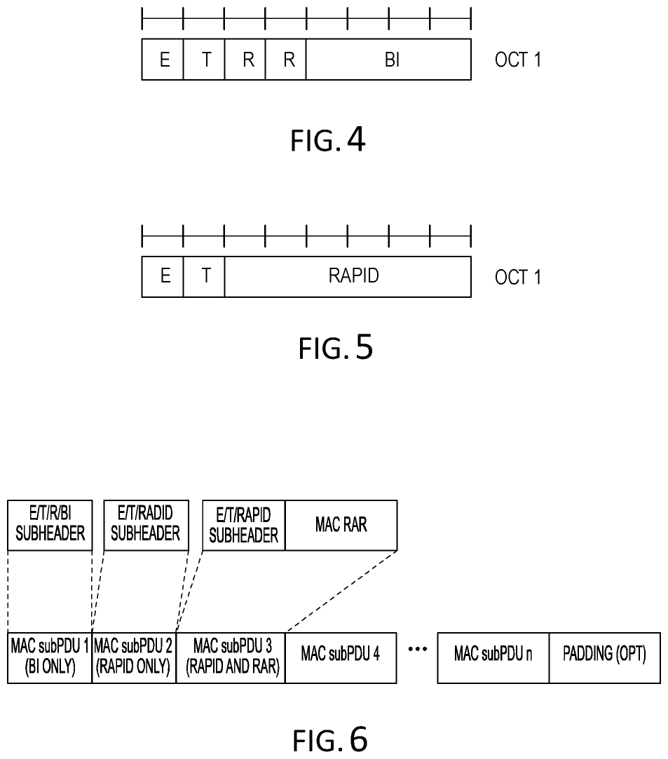

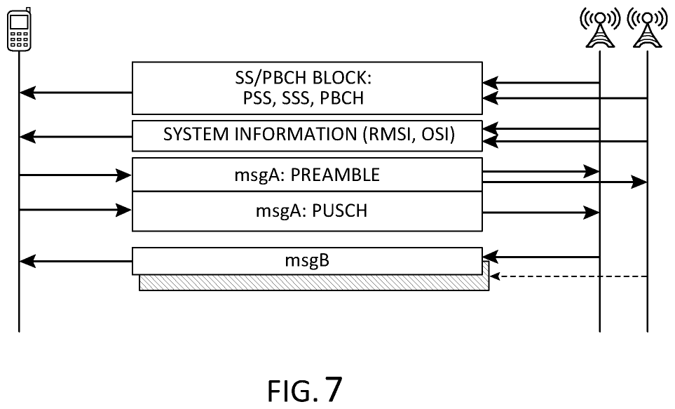

### DETAILED DESCRIPTION

Before describing in detail example embodiments, it is noted that the embodiments reside primarily in combinations of apparatus components and processing steps related to random access with slice grants for prioritized slices. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

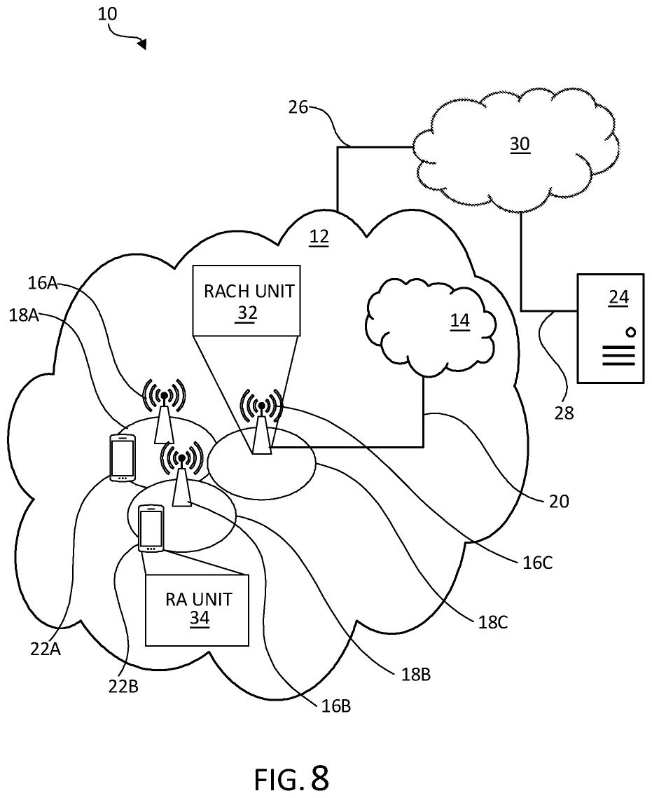

Some embodiments provide random access with slice grants for prioritized slices. Referring again to the drawing figures, in which like elements are referred to by like reference numerals, there is shown in FIG. 8 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 8 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a RACH unit 32 which is configured to transmit at least one random access response, RAR, message, the at least one RAR message being responsive to a received PRACH message from the WD and configured to provide at least a first grant and a second grant, the first grant configured to grant uplink resources to a WD on a first slice, the second grant configured to grant uplink resources to a WD on a second slice. A wireless device 22 is configured to include an RA unit 34 which is configured to identify a grant in the RAR message corresponding to one of a first slice and a second slice.

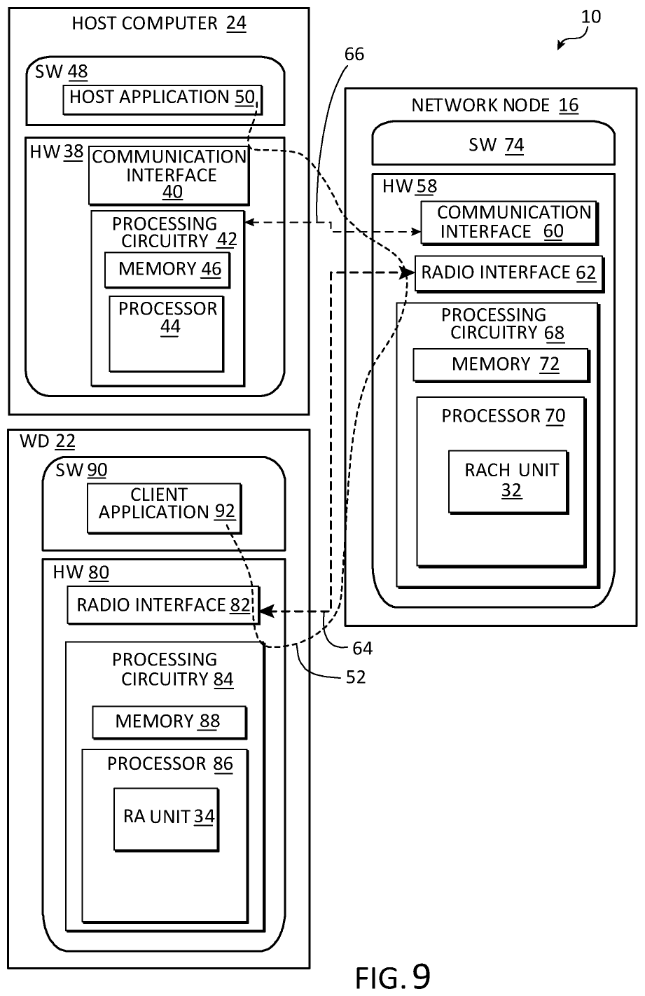

Example implementations, in accordance with an embodiment, of the WD 22, network node 16 and host computer 24 discussed in the preceding paragraphs will now be described with reference to FIG. 9. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include a RACH unit 32 which is configured to transmit at least one random access response, RAR, message the at least one RAR message being configured to provide at least a first grant and a second grant, the first grant configured to grant uplink resources to a WD on a first slice, the second grant configured to grant uplink resources to a WD on a second slice.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include an RA unit 34 which is configured to identify a grant in the RAR message corresponding to one of a first and a second slice.

In some embodiments, the inner workings of the network node 16, WD 22, and host computer 24 may be as shown in FIG. 9 and independently, the surrounding network topology may be that of FIG. 8.

In FIG. 9, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 8 and 9 show various “units” such as RACH unit 32, and RA unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

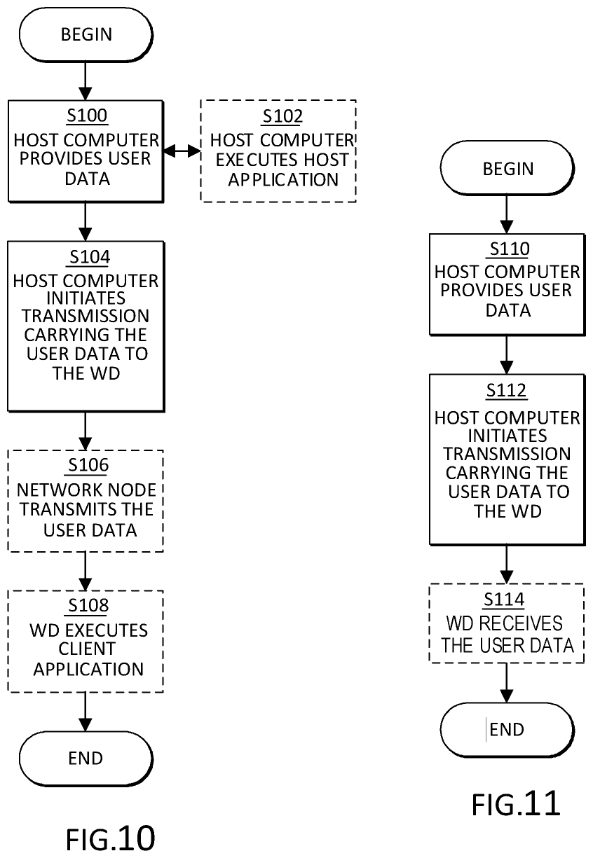

FIG. 10 is a flowchart illustrating an example method implemented in a communication system, such as, for example, the communication system of FIGS. 8 and 9, in accordance with one embodiment. The communication system may include a host computer 24, a network node 16 and a WD 22, which may be those described with reference to FIG. 9. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 11 is a flowchart illustrating an example method implemented in a communication system, such as, for example, the communication system of FIG. 8, in accordance with one embodiment. The communication system may include a host computer 24, a network node 16 and a WD 22, which may be those described with reference to FIGS. 8 and 9. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

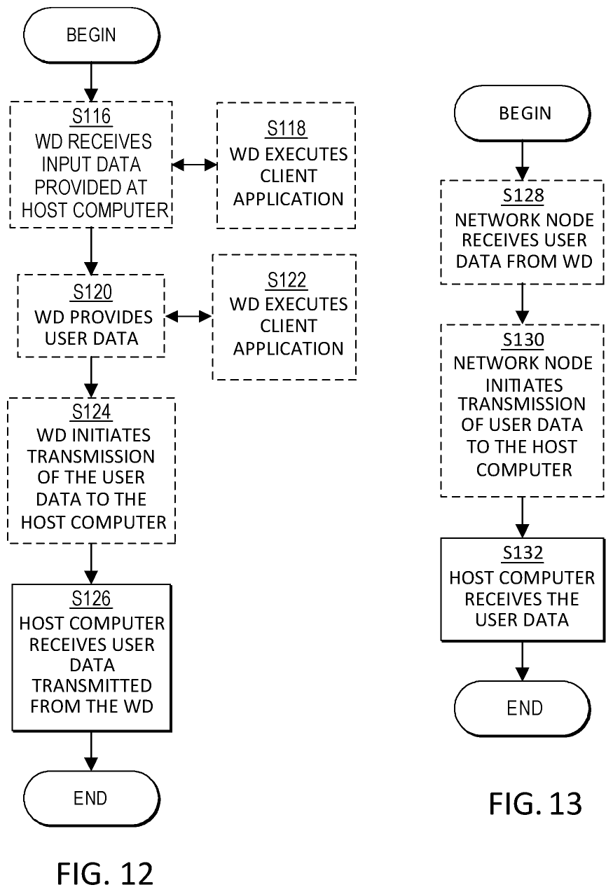

FIG. 12 is a flowchart illustrating an example method implemented in a communication system, such as, for example, the communication system of FIG. 8, in accordance with one embodiment. The communication system may include a host computer 24, a network node 16 and a WD 22, which may be those described with reference to FIGS. 8 and 9. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 13 is a flowchart illustrating an example method implemented in a communication system, such as, for example, the communication system of FIG. 8, in accordance with one embodiment. The communication system may include a host computer 24, a network node 16 and a WD 22, which may be those described with reference to FIGS. 8 and 9. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

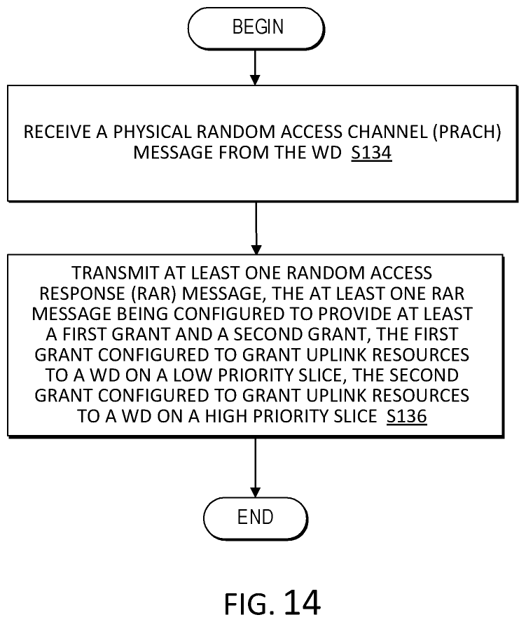

FIG. 14 is a flowchart of an example process in a network node 16 for random access with slice grants for prioritized slices. One or more blocks described herein may be performed by one or more elements of network node 16 such as by one or more of processing circuitry 68 (including the RACH unit 32), processor 70, radio interface 62 and/or communication interface 60. Network node 16 such as via processing circuitry 68 and/or processor 70 and/or radio interface 62 and/or communication interface 60 is configured to receive a PRACH message from the WD (Block S134). The process also includes transmitting at least one RAR message the at least one RAR message being configured to provide at least a first grant and a second grant, the first grant configured to grant uplink resources to a WD on a low priority slice, the second grant configured to grant uplink resources to a WD on a high priority slice (Block S136).

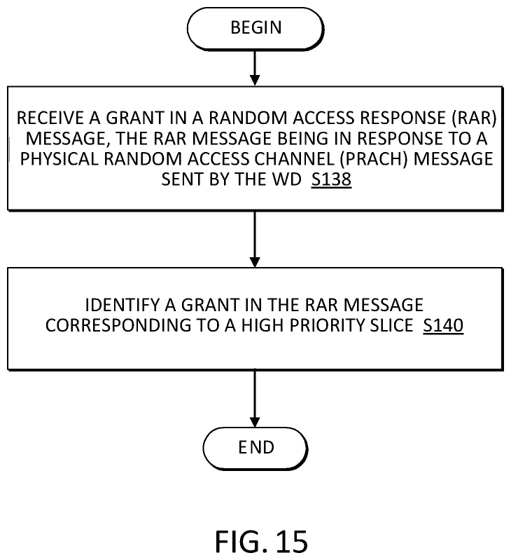

FIG. 15 is a flowchart of an example process in a wireless device 22 according to some embodiments of the present disclosure for random access with slice grants for prioritized slices. One or more blocks described herein may be performed by one or more elements of wireless device 22 such as by one or more of processing circuitry 84 (including the RA unit 34), processor 86, radio interface 82 and/or communication interface 60. Wireless device 22 such as via processing circuitry 84 and/or processor 86 and/or radio interface 82 is configured to receive a grant in an RAR message, the RAR message being in response to a PRACH message sent by the WD (S138). The process also includes identifying a grant in the RAR message corresponding to a high priority slice (S140).

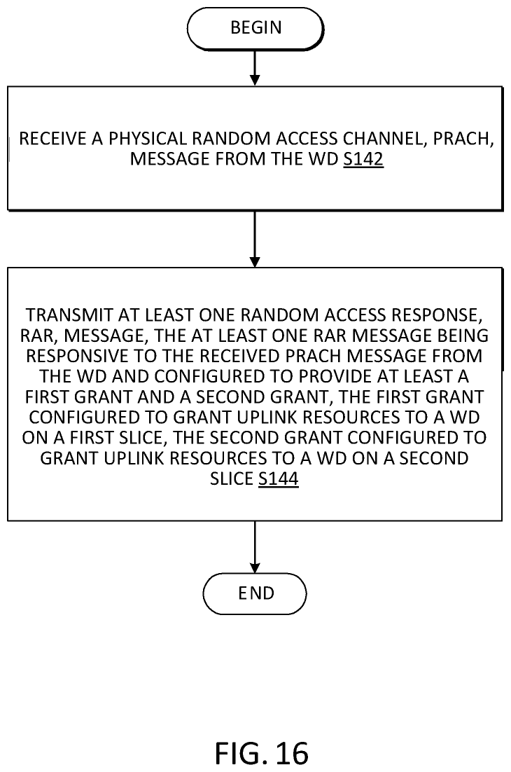

FIG. 16 is a flowchart of an example process in a network node 16 for random access with slice grants for prioritized slices. One or more blocks described herein may be performed by one or more elements of network node 16 such as by one or more of processing circuitry 68 (including the RACH unit 32), processor 70, radio interface 62 and/or communication interface 60. Network node 16 such as via processing circuitry 68 and/or processor 70 and/or radio interface 62 and/or communication interface 60 is configured to receive a physical random access channel, PRACH, message from the WD (Block S142); and transmitting at least one random access response, RAR, message, the at least one RAR message being responsive to the received PRACH message from the WD and configured to provide at least a first grant and a second grant, the first grant configured to grant uplink resources to a WD on a first slice, the second grant configured to grant uplink resources to a WD on a second slice (Block S144).

In some embodiments, one of the first slice and the second slice is of a higher priority than the other of the first slice and the second slice. In some embodiments, the first grant and the second grant are included in one RAR message. In some embodiments, an RAR message includes a preamble, the preamble indicating whether a grant provided by the RAR message is one of: for a WD on a low priority slice only; and for a WD on either one of a low priority slice and a high priority slice. In some embodiments, the method also includes responding with the first grant only, when the preamble falls within a first PRACH transmission occasion, and responding with both the first grant and the second grant when the preamble falls within a second PRACH occasion. In some embodiments, the second grant is added to a same medium access control, MAC, packet data unit, PDU as the first grant, the second grant being placed as a last RAR message of the MAC PDU. In some embodiments, the second grant is included in downlink control information, DCI. In some embodiments, the method also includes defining a random access-radio network temporary identifier, RA-RNTI that identifies the RAR message.

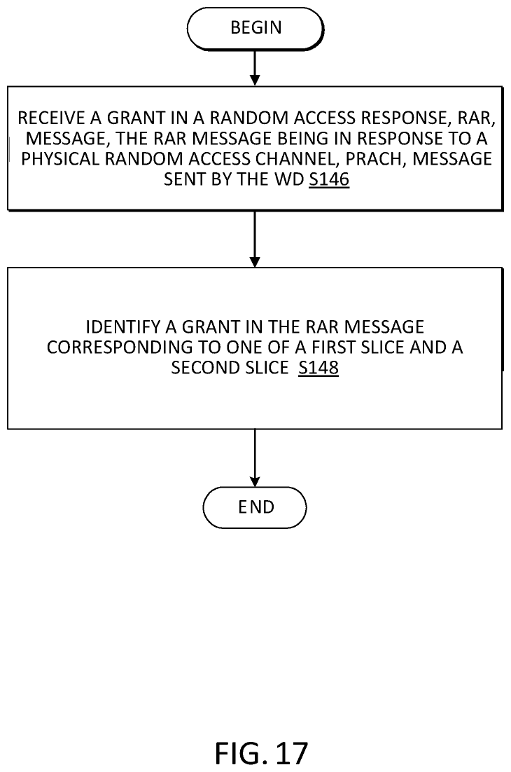

FIG. 17 is a flowchart of an example process in a wireless device 22 according to some embodiments of the present disclosure for random access with slice grants for prioritized slices. One or more blocks described herein may be performed by one or more elements of wireless device 22 such as by one or more of processing circuitry 84 (including the RA unit 34), processor 86, radio interface 82 and/or communication interface 60. Wireless device 22 such as via processing circuitry 84 and/or processor 86 and/or radio interface 82 is configured to receive a grant in a random access response, RAR, message, the RAR message being in response to a physical random access channel, PRACH, message sent by the WD (Block S146); and identify a grant in the RAR message corresponding to one of a high priority slice and a low priority slice, the high priority slice having a higher priority than the low priority slice (Block S148).

In some embodiments, one of the first slice and the second slice is of a higher priority than the other of the first slice and the second slice. In some embodiments, the method also includes monitoring one of a plurality of search spaces for an RAR message transmission corresponding to one of the first slice and the second slice, each search space corresponding to a slice. In some embodiments, the grant in the RAR message corresponding to the first slice is indicated in a preamble, the preamble indicating a second grant. In some embodiments, the method also includes listening for a physical downlink control channel, PDCCH, transmission addressed to a random access radio network temporary identifier, RA-RNTI, to identify the RAR message.

Having described the general process flow of arrangements of the disclosure and having provided examples of hardware and software arrangements for implementing the processes and functions of the disclosure, the sections below provide details and examples of arrangements for random access with slice grants for prioritized slices.

Second Grant for Slice WDs Using R-Bits

In some embodiments, the RAR message will give two grants instead of one grant. In legacy radio access technologies, only one grant is given by the RAR message. The legacy WD is unaware of the giving of two grants and will utilize the normal (i.e., first) grant as before. The high priority slice WD 22 may utilize the second grant. Also, in some embodiments, the WD 22 may be aware of both the first and second grants but is configured to use only the first grant. In some embodiments, the WD 22 may be configured to use the first grant only for accessing a low priority slice or a high priority slice, and use the second grant only for accessing the other of the low priority slice and the high priority slice. In some embodiments, the first grant may be for a slice having a lower priority than a priority of a slice indicated by the second grant, or vice versa. Thus, in some embodiments, a slice for a legacy WD 22 may have a higher priority than a slice for a non-legacy WD 22. In other words, any grant can have any priority to place the grants in a particular priority order, such as in cases where there are more than two grants.

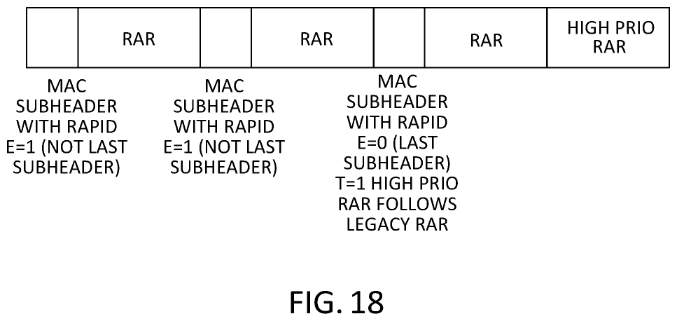

The presence of a second grant can be signaled by setting the T-bit in the MAC Subheader for RAR to “1”. When set to “1”, the second grant:
1) May be the same as the legacy grant in the RAR message except for a specific offset in time and or frequency. Very limited new signaling may be needed in this case. The size of offset(s) could be either hard coded in the specification or indicated in System Information (SI);
2) May be part of a second RAR message multiplexed in the same MAC PDU after the RAR of the legacy and low-priority slice WD 22. In this case it is placed as the last RAR message in the MAC PDU so that the legacy and low-priority slice WDs 22 do not search for an additional RAR message after the legacy RAR message. This is illustrated in FIG. 18;
3) May be conveyed in a new RAR message addressed to the same RA-RNTI and RAPID and sent in a slot following the first RAR. In this case, the legacy WD 22 has used the grant in the first RAR message and will not receive the second RAR message; and/or
4) May be conveyed in the downlink control information (DCI). This can be done by adding a new index indicating the slice id or the slice group.

The above may be generalized to more than two groups (prioritized/not prioritized). For example, N grants (to N−1 prioritized groups) can be given in items 1-4 above together with specifying the order that users from specific groups should utilize the grants.

RAR Message for Slice WD Identified by New RA-RNTI

In some embodiments, a new RA-RNTI is defined so that only the high priority slice WD 22 (and not legacy WDs 22) will identify the RAR message. This means that after preamble transmission, the high priority slice WD 22 may listen for a physical downlink control channel (PDCCH) transmission addressed to this new RA-RNTI (to identify that RAR message transmission). From 3GPP TS 38.321, the legacy RA-RNTI is given by:

RA-RNTI=1+s_id+14×t_id+14×80×f_id+14×80×8×ul_carrier_id

where s_id is the index of the first orthogonal frequency division multiplexed (OFDM) symbol of the physical random access channel (PRACH) occasion (0≤s_id<14), t_id is the index of the first slot of the PRACH occasion in a system frame (0≤t_id<80), where the subcarrier spacing to determine t_id is based on the value of specified in clause 5.3.2 in 3GPP TS 38.211 [8], f_id is the index of the PRACH occasion in the frequency domain (0≤f_id<8), and ul_carrier_id is the uplink (UL) carrier used for Random Access Preamble transmission (0 for NUL carrier, and 1 for supplementary uplink (SUL) carrier).

Options to define a new slice RA-RNTI may include:
1. Including an index of the slice or slice group in the formula:
   a) In one example:
      i) RA-RNTI=1+s_id+14×t_id+14×80×f_id+14×80×8×ul_carrier_id*slice_id;
   b) In another example:
      i) RA-RNTI=1+s_id+14×t_id+14×80×f_id+14×80×8×ul_carrier_id*slice_group_id;
2. If 2-step RA is not configured in the cell, the MsgB-RNTI may be used as slice RA-RNTI;
3. If SUL in not configured, setting ul_carrier_id to “1” may be used as slice RA-RNTI;
4. In cases where the configuration includes values for other parameters that are not used, these can be used for the new slice RA-RNTI. For example, if PRACH occasions in the frequency domain (f_id) only use values 0-3 in the used configuration, setting the f_id value to “4-7” (and the other values as in the legacy RA-RNTI) may give a slice RA-RNTI; and/or
5. Another example is to use values of t_id which are not used and which therefore can be reused for indicating the slice or slice group on which RA was initiated. For example, in case subcarrier spacing (SCS) of 120 kHz is not configured in the cell, then value ranges of t_id corresponding to SCS 120 kHz can be reused for slice RA-RNTI, i.e., indicating the slice or slice group on which the RA was initiated.

New Slice Specific Search Space for Slice RAR

In some embodiments, a new search space is defined for slice RAR. In this case, the slice WD 22 may, after the preamble transmission, monitor the PDCCH on this new search space for a RAR message transmission.

Shared RACH Resources to Decrease Overhead from Unused Grants

Since the network node 16 is unaware if the preamble transmission is from a legacy WD 22 or a slice WD 22, the network node 16 might need to give two grants (unless the slice WD 22 also uses the legacy RAR message which would lead to increased collision probability), which may lead to extra overhead. A way to overcome this is to define a subset of preambles where the network node 16 will reply with two RAR messages. For example, preambles with ID 0-9 may be indicated as preambles which will give a second grant (in one of the ways described above), while the other preambles will not. In this way, preambles 0-9 are shared by both legacy and high priority slice WDs 22, while the other preambles are used by only legacy WDs 22. This may steer the high priority slice WDs 22 to these preambles while the legacy WDs 22 may evenly use all preambles.

A similar rule may apply to a configured subset of PRACH occasions, so that if a preamble is transmitted in one of these PRACH occasions, the network node 16 will respond with two grants according to the above methods while if the preamble is transmitted in another PRACH occasion, the network node 16 may only send a legacy RAR message.

According to one aspect, a network node 16 is configured to communicate with a WD 22. The network node 16 includes a radio interface 62 and/or processing circuitry 68 configured to receive a PRACH message from the WD 22, and transmit at least one random access response, RAR, message the at least one RAR message being configured to provide at least a first grant and a second grant, the first grant configured to grant uplink resources to a WD 22 on a low priority slice, the second grant configured to grant uplink resources to a WD 22 on a high priority slice.

According to this aspect, in some embodiments, the first grant and the second grant are included in one RAR message. In some embodiments, an RAR message includes a preamble, the preamble indicating whether the grant is for a WD 22 on a low priority slice only, or for WDs 22 on either one of a low priority slice and a high priority slice. In some embodiments, the network node 16, radio interface 62 and/or processing circuitry 68 are further configured to respond with the first grant only, when a preamble falls within a first PRACH transmission occasion, and to respond with both the first grant and the second grant when a preamble falls within a second PRACH occasion. In some embodiments, the second grant is added to a same medium access control, MAC, packet data unit, PDU as the first grant, the second grant being placed as a last RAR message of the MAC PDU. In some embodiments, the second grant is included in downlink control information, DCI. In some embodiments, the network node 16, radio interface 62 and/or processing circuitry 68 are further configured to define and transmit a random access-radio network temporary identifier, RA-RNTI, that identifies the RAR message.

According to another aspect, a method implemented in a network node 16 includes receiving a physical random access channel, PRACH, message from the WD 22, and transmitting at least one random access response, RAR, message the at least one RAR message being configured to provide at least a first grant and a second grant, the first grant configured to grant uplink resources to a WD 22 on a low priority slice, the second grant configured to grant uplink resources to a WD 22 on a high priority slice.

According to this aspect, in some embodiments, the first grant and the second grant are included in one RAR message. In some embodiments, an RAR message includes a preamble, the preamble indicating whether the grant is for a WD 22 on a low priority slice only, or for WDs 22 on either one of a low priority slice and a high priority slice. In some embodiments, the method includes responding with the first grant only, when a preamble falls within a first PRACH transmission occasion, and responding with both the first grant and the second grant when a preamble falls within a second PRACH occasion. In some embodiments, the second grant is added to a same medium access control, MAC, packet data unit, PDU as the first grant, the second grant being placed as a last RAR message of the MAC PDU. In some embodiments, the second grant is included in downlink control information, DCI. In some embodiments, the method further includes defining and transmitting a random access-radio network temporary identifier, RA-RNTI that identifies the RAR message.

According to yet another aspect, a WD 22 is configured to communicate with a network node 16. The WD 22 includes a radio interface 82 and/or processing circuitry 84 configured to receive a grant in a random access response, RAR, message, the RAR message being in response to a physical random access channel, PRACH, message sent by the WD 22; and identify a grant in the RAR message corresponding to a high priority slice.

According to this aspect, in some embodiments, the WD 22, radio interface 82 and/or processing circuitry 84 are further configured to monitor one of a plurality of search spaces for an RAR message transmission corresponding to the high priority slice, each search space corresponding to a slice. In some embodiments, the grant in the RAR message corresponding to the high priority slice is indicated in a preamble, the preamble indicating a second grant. In some embodiments, the WD 22, radio interface 82 and/or processing circuitry 84 is configured to listen for a physical downlink control channel, PDCCH, transmission addressed to a random access radio network temporary identifier, RA-RNTI, to identify the RAR message.

According to yet another aspect, a method implemented in a WD 22 includes receiving a grant in a random access response, RAR, message, the RAR message being in response to a physical random access channel, PRACH, message sent by the WD 22; and identifying a grant in the RAR message corresponding to a high priority slice.

According to this aspect, in some embodiments, the method further includes monitoring one of a plurality of search spaces for an RAR message transmission corresponding to the high priority slice, each search space corresponding to a slice. In some embodiments, the grant in the RAR message corresponding to the high priority slice is indicated in a preamble, the preamble indicating a second grant. In some embodiments, the method further includes listening for a physical downlink control channel, PDCCH, transmission addressed to a random access radio network temporary identifier, RA-RNTI, to identify the RAR message.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments may include one or more of the following:

Embodiment A1. A network node configured to communicate with a wireless device, WD, the network node configured to, and/or comprising a radio interface and/or comprising processing circuitry configured to:
receive a physical random access channel, PRACH, message from the WD; and
transmit at least one random access response, RAR, message the at least one RAR message being configured to provide at least a first grant and a second grant, the first grant configured to grant uplink resources to a WD on a low priority slice, the second grant configured to grant uplink resources to a WD on a high priority slice.

Embodiment A2. The network node of Embodiment A1, wherein the first grant and the second grant are included in one RAR message.

Embodiment A3. The network node of Embodiment A1, wherein an RAR message includes a preamble, the preamble indicating whether the grant is for a WD on a low priority slice only, or for WDs on either one of a low priority slice and a high priority slice.

Embodiment A4. The network node of Embodiment A1, wherein the network node, radio interface and/or processing circuitry are further configured to respond with the first grant only, when a preamble falls within a first PRACH transmission occasion, and to respond with both the first grant and the second grant when a preamble falls within a second PRACH occasion.

Embodiment A5. The network node of Embodiment A1, wherein the second grant is added to a same medium access control, MAC, packet data unit, PDU as the first grant, the second grant being placed as a last RAR message of the MAC PDU.

Embodiment A6. The network node of Embodiment A1, wherein the second grant is included in downlink control information, DCI.

Embodiment A7. The network node of Embodiment A1, wherein the network node, radio interface and/or processing circuitry are further configured to define and transmit a random access-radio network temporary identifier, RA-RNTI, that identifies the RAR message.

Embodiment B1. A method implemented in a network node, the method comprising:
receiving a physical random access channel, PRACH, message from the WD; and
transmitting at least one random access response, RAR, message the at least one RAR message being configured to provide at least a first grant and a second grant, the first grant configured to grant uplink resources to a WD on a low priority slice, the second grant configured to grant uplink resources to a WD on a high priority slice.

Embodiment B2. The method of Embodiment B1, wherein the first grant and the second grant are included in one RAR message.

Embodiment B3. The method of Embodiment B1, wherein an RAR message includes a preamble, the preamble indicating whether the grant is for a WD on a low priority slice only, or for WDs on either one of a low priority slice and a high priority slice.

Embodiment B4. The method of Embodiment B1, further comprising responding with the first grant only, when a preamble falls within a first PRACH transmission occasion, and responding with both the first grant and the second grant when a preamble falls within a second PRACH occasion.

Embodiment B5. The method of Embodiment B1, wherein the second grant is added to a same medium access control, MAC, packet data unit, PDU as the first grant, the second grant being placed as a last RAR message of the MAC PDU.

Embodiment B6. The method of Embodiment B1, wherein the second grant is included in downlink control information, DCI.

Embodiment B7. The method of Embodiment B1, further comprising defining and transmitting a random access-radio network temporary identifier, RA-RNTI that identifies the RAR message.

Embodiment C1. A wireless device, WD, configured to communicate with a network node, the WD configured to, and/or comprising a radio interface and/or processing circuitry configured to:
receive a grant in a random access response, RAR, message, the RAR message being in response to a physical random access channel, PRACH, message sent by the WD; and
identify a grant in the RAR message corresponding to a high priority slice.

Embodiment C2. The WD of Embodiment C1, wherein the WD, radio interface and/or processing circuitry are further configured to monitor one of a plurality of search spaces for an RAR message transmission corresponding to the high priority slice, each search space corresponding to a slice.

Embodiment C3. The WD of Embodiment C1, wherein the grant in the RAR message corresponding to the high priority slice is indicated in a preamble, the preamble indicating a second grant.

Embodiment C4. The WD of Embodiment C1, wherein the WD, radio interface and/or processing circuitry is configured to listen for a physical downlink control channel, PDCCH, transmission addressed to a random access radio network temporary identifier, RA-RNTI, to identify the RAR message.

Embodiment D1. A method implemented in a wireless device (WD), the method comprising:
receiving a grant in a random access response, RAR, message, the RAR message being in response to a physical random access channel, PRACH, message sent by the WD; and
identifying a grant in the RAR message corresponding to a high priority slice.

Embodiment D2. The method of Embodiment D1, further comprising monitoring one of a plurality of search spaces for an RAR message transmission corresponding to the high priority slice, each search space corresponding to a slice.

Embodiment D3. The method of Embodiment D1, wherein the grant in the RAR message corresponding to the high priority slice is indicated in a preamble, the preamble indicating a second grant.

Embodiment D4. The method of Embodiment D1, further comprising listening for a physical downlink control channel, PDCCH, transmission addressed to a random access radio network temporary identifier, RA-RNTI, to identify the RAR message.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:
AMF Access and Mobility Management Function
C-RNTI Cell-RNTI
CBRA Contention Based RA
CFRA Contention Free RA
CU Centralized Unit
CP Cyclic Prefix
DMRS Demodulation Reference Signal
DU Distributed Unit
NR New Radio
NW Network
PRACH Physical RACH
PDSCH Physical Downlink Shared Channel
PDU Packet Data Unit
PUSCH Physical Uplink Shared Channel
RA Random Access
RACH Random Access Channel
RAN Radio Access Network
RAR Random Access Response
RAT Radio Access Technology
RNL Radio Network Layer
RNTI Radio Network Temporary Identifier
RRC Radio Resource Control
TC-RNTI Temporary C-RNTI
TNL Transport Network Layer

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A network node configured to communicate with a wireless device, WD, the network node comprising:
a radio interface configured to:
receive a physical random access channel, PRACH, message from the WD; and
transmit at least one random access response, RAR, message, the at least one RAR message being responsive to the received PRACH message from the WD and configured to provide at least a first grant and a second grant, the first grant configured to grant uplink resources to a WD on a first slice, the second grant configured to grant uplink resources to a WD on a second slice.

2. The network node of claim 1, wherein one of the first slice and the second slice is of a higher priority than the other of the first slice and the second slice.

3. The network node of claim 1, wherein the first grant and the second grant are included in one RAR message.

4. The network node of claim 1, wherein an RAR message includes a preamble, the preamble indicating whether a grant provided by the RAR message is one of:
for a WD on a low priority slice only; and
for a WD on either one of a low priority slice and a high priority slice.

5. The network node of claim 4, wherein the radio interface is further configured to respond with the first grant only, when the preamble falls within a first PRACH transmission occasion, and to respond with both the first grant and the second grant when the preamble falls within a second PRACH occasion.

6. The network node of claim 1, wherein the second grant is added to a same medium access control, MAC, packet data unit, PDU as the first grant, the second grant being placed as a last RAR message of the MAC PDU.

7. The network node of claim 1, wherein the second grant is included in downlink control information, DCI.

8. The network node of claim 1, further comprising processing circuitry configured to define a random access-radio network temporary identifier, RA-RNTI, that identifies the RAR message.

9. A method implemented in a network node configured to communicate with a WD, the method comprising:
receiving a physical random access channel, PRACH, message from the WD; and
transmitting at least one random access response, RAR, message, the at least one RAR message being responsive to the received PRACH message from the WD and configured to provide at least a first grant and a second grant, the first grant configured to grant uplink resources to a WD on a first slice, the second grant configured to grant uplink resources to a WD on a second slice.

10. The method of claim 9, wherein one of the first slice and the second slice is of a higher priority than the other of the first slice and the second slice.

11. The method of claim 9, wherein the first grant and the second grant are included in one RAR message.

12. The method of claim 9, wherein an RAR message includes a preamble, the preamble indicating whether a grant provided by the RAR message is one of:
for a WD on a low priority slice only; and
for a WD on either one of a low priority slice and a high priority slice.

13. The method of claim 12, further comprising responding with the first grant only, when the preamble falls within a first PRACH transmission occasion, and responding with both the first grant and the second grant when the preamble falls within a second PRACH occasion.

14. The method of claim 9, wherein the second grant is added to a same medium access control, MAC, packet data unit, PDU as the first grant, the second grant being placed as a last RAR message of the MAC PDU.

15. The method of claim 9, wherein the second grant is included in downlink control information, DCI.

16. The method of claim 9, further comprising defining a random access-radio network temporary identifier, RA-RNTI that identifies the RAR message.

17. A wireless device, WD, configured to communicate with a network node, the WD comprising:
a radio interface configured to receive a grant in a random access response, RAR, message, the RAR message being in response to a physical random access channel, PRACH, message sent by the WD; and
processing circuitry in communication with the radio interface and configured to identify a grant in the RAR message corresponding to one of a first slice and a second slice.

18. The WD of claim 17, wherein one of the first slice and the second slice is of a higher priority than the other of the first slice and the second slice.

19. The WD of claim 17, wherein the processing circuitry is further configured to monitor one of a plurality of search spaces for an RAR message transmission corresponding to one of the first slice and the second slice, each search space corresponding to a slice.

20. The WD of claim 17, wherein the grant in the RAR message corresponding to the first slice is indicated in a preamble, the preamble indicating a second grant.

21. The WD of claim 17, wherein the radio interface is further configured to listen for a physical downlink control channel, PDCCH, transmission addressed to a random access radio network temporary identifier, RA-RNTI, to identify the RAR message.

22. A method implemented in a wireless device, WD, the method comprising:
receiving a grant in a random access response, RAR, message, the RAR message being in response to a physical random access channel, PRACH, message sent by the WD; and
identifying a grant in the RAR message corresponding to one of a first slice and a second slice.

23. The method of claim 22, wherein one of the first slice and the second slice is of a higher priority than the other of the first slice and the second slice.

24. The method of claim 22, further comprising monitoring one of a plurality of search spaces for an RAR message transmission corresponding to one of the first slice and the second slice, each search space corresponding to a slice.

25. The method of claim 22, wherein the grant in the RAR message corresponding to the first slice is indicated in a preamble, the preamble indicating a second grant.

26. The method of claim 22, further comprising listening for a physical downlink control channel, PDCCH, transmission addressed to a random access radio network temporary identifier, RA-RNTI, to identify the RAR message.
